(19) United States
(12) Patent Application Publication
(10) Pub. No.: US 2025/0353752 A1
(43) Pub. Date: Nov. 20, 2025

(54) PREPARATION METHOD FOR SILICON DIOXIDE AEROGEL AND SILICON DIOXIDE AEROGEL

(71) Applicant: HUNAN ALFY NEW MATERIAL CO., LTD, Liuyang (CN)

(72) Inventors: Dingri ZHANG, Liuyang (CN); Miao SONG, Liuyang (CN); Lichun LONG, Liuyang (CN)

(21) Appl. No.: 19/283,099

(22) Filed: Jul. 28, 2025

Related U.S. Application Data
(63) Continuation of application No. PCT/CN2023/133313, filed on Nov. 22, 2023.

(30) Foreign Application Priority Data
Feb. 1, 2023 (CN) 202310050718.0

(51) Int. Cl. C01B 33/158

(52) U.S. Cl. CPC C01B 33/1585; C01P 2004/04

(57) ABSTRACT

Disclosed are a preparation method for a SiO₂ aerogel and a SiO₂ aerogel, and belongs to the technical field of chemical coatings. The preparation method for the SiO₂ aerogel comprises the following steps: S100: uniformly mixing an inorganic silicon source, water, a surfactant and an acid catalyst, and gelating the mixture to obtain a wet gel; S200: uniformly mixing a surfactant, a cosolvent and a low-surface-tension solvent to obtain a reverse micelle extraction solution; S300: mixing the wet gel obtained in the step S100 with the reverse micelle extraction solution obtained in the step S200, and soaking the mixture to obtain a gel; and S400: drying the gel obtained in the step S300 to obtain the SiO₂ aerogel.

### CROSS-REFERENCE TO RELATED APPLICATIONS

This application is a continuation of International Patent Application No. PCT/CN2023/133313 with a filing date of Nov. 22, 2023, designating the United States, now pending, and further claims priority to Chinese Patent Application No. 202310050718. 0 with a filing date of Feb. 1, 2023. The content of the aforementioned applications, including any intervening amendments thereto, are incorporated herein by reference.

### TECHNICAL FIELD

The present application belongs to the technical field of chemical coatings, and particularly relates to a preparation method for a SiO₂ aerogel and a SiO₂ aerogel.

### BACKGROUND OF THE PRESENT INVENTION

Silicon dioxide (SiO₂) aerogel is a solid material which is formed by nano-particle packing and has a three-dimensional nanoporous structure, has the characteristics of chemical inertia, thermal insulation, sound insulation and noise reduction, shock absorption, selective adsorption and the like, and has been applied in many fields, such as industrial thermal insulation and energy conservation, power battery safety and fire prevention, automobile energy conservation and sound insulation, building energy conservation, space craft thermal and cold insulation, and refrigerator cold insulation, in batches, thus having a very broad application potential.

Although the SiO₂ aerogel has excellent performance, there are still some shortcomings in its preparation method, especially in industrial preparation of the SiO₂ aerogel, which greatly limits its further popularization and application. For example, at present, most of silicon sources used in preparation of the SiO₂ aerogel are organic silicon sources, such as tetraethyl orthosilicate, tetramethyl orthosilicate and polysiloxane, the organic silicon sources are expensive and have a large price fluctuation, and a production capacity of the organic silicon sources is greatly affected by the monocrystalline silicon industry. Moreover, adopted organic silane modifiers, such as trimethyl chlorosilane and hexamethyl disilazane, are also expensive, so that a production cost of the SiO₂ aerogel is greatly increased. Therefore, the use of the above organic silicon sources and the above organic silane modifiers leads to a high product cost, which restricts the large-scale production and industrial application of the SiO₂ aerogel. In addition, current preparation of the SiO₂ aerogel mostly adopts a supercritical drying technology. However, equipment used in the supercritical drying technology is complicated and high in cost, and has certain dangers. Under influences of the equipment and the production capacity, the SiO₂ aerogel prepared by the supercritical drying technology is difficult to meet increasing market demand. In addition, some existing SiO₂ aerogels are prepared by a conventional ambient-pressure drying technology, but complicated solvent replacement steps are needed when preparing the SiO₂ aerogel by the conventional ambient-pressure drying technology, so that there are a long production cycle and a high cost.

### SUMMARY OF THE PRESENT INVENTION

In view of the above problems, the present invention aims to solve at least one of the technical problems in related arts to some extent. Therefore, the present invention provides a preparation method for a SiO₂ aerogel and a SiO₂ aerogel, which can ease the problems of limited production capacity of organic silicon source, high prices of raw materials such as an organic silicon modifier, high production cost and the like in current preparation, the preparation method is low in production cost and short in preparation cycle, and the prepared SiO₂ aerogel product has excellent performance.

In order to solve the above technical problems, the present application is implemented as follows.

According to one aspect of the present application, a preparation method for a SiO₂ aerogel is provided, which comprises the following steps:
S100: uniformly mixing an inorganic silicon source, water, a surfactant and an acid catalyst, and gelating the mixture to obtain a wet gel;
S200: uniformly mixing a surfactant, a cosolvent and a low-surface-tension solvent to obtain a reverse micelle extraction solution;
S300: mixing the wet gel obtained in the step S100 with the reverse micelle extraction solution obtained in the step S200, and soaking the mixture to obtain a gel; and
S400: drying the gel obtained in the step S300 to obtain the SiO₂ aerogel.

In addition, the preparation method for the SiO₂ aerogel according to the present application may further have the following additional technical features.

In some embodiments, when a SiO₂ aerogel composite material is prepared by the method, the step S100 in the preparation method comprises: uniformly mixing the inorganic silicon source, the water, the surfactant and the acid catalyst to obtain a mixed solution; and impregnating a hydrophilic carrier with the mixed solution, and then gelating the carrier to obtain a wet gel composite material.

In some embodiments, the hydrophilic carrier comprises at least one of a glass fiber felt, a pre-oxidized fiber felt, a ceramic fiber felt, expanded perlite, sepiolite or a melamine foam.

In some embodiments, in the step S100, a mass ratio of the inorganic silicon source to the water, the surfactant and the acid catalyst is 1:2-4:0.02-0.06:0.05-3; and/or, in the step S200, a mass ratio of the surfactant to the cosolvent and the low-surface-tension solvent is 1:8-25:120-250.

In some embodiments, in the step S300, a soaking time is 0.5 hour to 6 hours, and a soaking temperature is 25° C.-50° C.; preferably, in the step S300, a mass ratio of the wet gel to the reverse micelle extraction solution is 1:1.5-2.5; preferably, in the step S400, the drying is ambient-pressure staged heating drying; preferably, the staged heating drying comprises: under an ambient pressure, treating at 70° C.-90° C. for 1 hour-2 hours first, and then treating at 140° C.-160° C. for 1 hour-2 hours; and preferably, evaporated solvent is collected during the drying, and the collected solvent is returned to the step S200 or the step S300 for reuse.

In some embodiments, the inorganic silicon source comprises at least one of water-soluble silicate, water-soluble alkane-modified silicate or alkaline silica sol; preferably, the inorganic silicon source is the water-soluble alkane-modified silicate, or a mixture of the water-soluble alkane-modified silicate and the water-soluble silicate, or a mixture of the water-soluble alkane-modified silicate and the alkaline silica sol, or a mixture of the water-soluble alkane-modified silicate, the water-soluble silicate and the alkaline silica sol; preferably, the water-soluble silicate comprises at least one of sodium silicate, potassium silicate, lithium silicate, hydrated sodium silicate, hydrated potassium silicate or hydrated lithium silicate; preferably, the water-soluble alkane-modified silicate is CₙH₂ₙ₊₁Si(OM)₃, wherein n<8, and M comprises at least one of Na, K or Li; and preferably, a content of SiO₂ in the alkaline silica sol is 25%-40%; and/or, a pH value of the alkaline silica sol is 9-11; and/or, an average particle size of the alkaline silica sol is 10 nm to 20 nm.

In some embodiments, the acid catalyst comprises at least one of hydrofluoric acid, hydrochloric acid, sulfuric acid, nitric acid, phosphoric acid, oxalic acid, acetic acid, ammonium chloride, sodium bisulfate, ammonium sulfate or ammonium fluoride; and/or, the surfactant comprises at least one of sodium dodecyl sulfate, cetyl trimethyl ammonium bromide, tetradecyl betaine, polyoxyethylene ether, sodium perfluorooctane sulfonate, sodium perfluorooctanoate, 1-Hexadecylsulfonic acid sodium salt, sodium perfluorododecyl sulfate or perfluorododecyl polyoxyethylene ether.

In some embodiments, the cosolvent comprises at least one of an alcohol solvent, an aldehyde solvent, a ketone solvent, an ether solvent or a phenol solvent, and preferably, the cosolvent comprises at least one of methanol, n-propanol, isopropanol, n-butanol, isobutanol, n-pentanol, isopentanol, 1-hexanol, 2-hexanol, 1-octanol, ethanol, acetaldehyde, acetone, ether or p-nonylphenol; and/or, the low-surface-tension solvent comprises at least one of an alkane solvent, an alkene solvent or a benzene solvent, and preferably, the low-surface-tension solvent comprises at least one of n-hexane, n-heptane, n-pentane, toluene, hexamethyl disiloxane, trimethyl hydroxysilane, hexamethyl cyclotrisiloxane, octamethyl cyclotetrasiloxane, monochlorotrifluoropropene, monofluorotrichloromethane or 1,1,2-trifluorotrichloroethane.

According to another aspect of the present application, a SiO₂ aerogel is provided, wherein the SiO₂ aerogel is prepared by the above preparation method.

In some embodiments, a specific surface area of the SiO₂ aerogel is ≥600 m²/g, and a thermal conductivity coefficient of the SiO₂ aerogel is ≤0.015 W/(m·K); and preferably, a density of the SiO₂ aerogel is ≤0.15 g/cm³, and a contact angle of the SiO₂ aerogel is >90°.

In some embodiments, a SiO₂ aerogel composite material may also be obtained by the above preparation method, wherein a specific surface area of the SiO₂ aerogel composite material is ≥600 m²/g, and a thermal conductivity coefficient of the SiO₂ aerogel composite material is ≤0.021 W/(m·K).

Compared with the prior art, the implementation of the technical solution of the present invention has at least the following beneficial effects.

According to the preparation method for the SiO₂ aerogel provided by the embodiment of the present application, the inorganic silicon source serving as a precursor is low in cost, widely available and easy to obtain, can solve the problems of limited production capacity of currently adopted organic silicon source, high price of organic silicon modifier and the like, and is conductive to reducing a production cost; and meanwhile, a reverse micelle extraction step is utilized instead of a wet gel solvent replacement step and a deionization step, which can avoid a complicated solvent replacement process, and the gel may be dried by ambient-pressure drying, such as ambient-pressure staged drying, and the evaporated solvent may be reused, so that a production cycle is greatly shortened and a material cost is greatly reduced, and the defects of high cost and long production cycle in preparation of the SiO₂ aerogel in the prior art can be better solved, thus having broad market prospects.

The preparation method of the present application may be used for preparing the SiO₂ aerogel and may also be used for preparing the SiO₂ aerogel composite material, and has the advantages of short production cycle, low production cost and among others, thus being suitable for realizing industrial production.

The additional aspects and advantages of the present application will be given in part in the following description, and will become apparent in part from the following description, or will be learned through the practice of the present application.

### DESCRIPTION OF THE DRAWINGS

FIG. 1 is a flow chart of a preparation method for a SiO₂ aerogel provided by some illustrative embodiments of the present application;

FIG. 2 is a microscopic TEM diagram of the SiO₂ aerogel prepared in Embodiment 1 of the present application; and

FIG. 3 is an isothermal nitrogen adsorption and desorption curve graph of the SiO₂ aerogel prepared in the embodiment of the present application.

### DETAILED DESCRIPTION OF PREFERRED EMBODIMENTS

The technical solutions in embodiments of the present application are clearly and completely described hereinafter with reference to the drawings in the embodiments of the present application. Apparently, the described embodiments are some but not all of the embodiments of the present application. Based on the embodiments of the present application, all other embodiments obtained by those of ordinary skills in the art without going through any creative work should fall within the scope of protection of the present application.

As mentioned in the background, there are still more or less defects in a technological method for preparing a SiO₂ aerogel in the related arts, such as the prior arts of CN106865558A, CN104556063A, CN108584965A, CN108751206A, CN108862285A and the like disclosed in the related arts, and there is still a need for improvement. In view of this, the technical solution of the embodiment in the present application provides a preparation method for a SiO₂ aerogel, and the SiO₂ aerogel prepared by the method can effectively shorten a production cycle and reduce a cost. The description of specific technical solution is as follows.

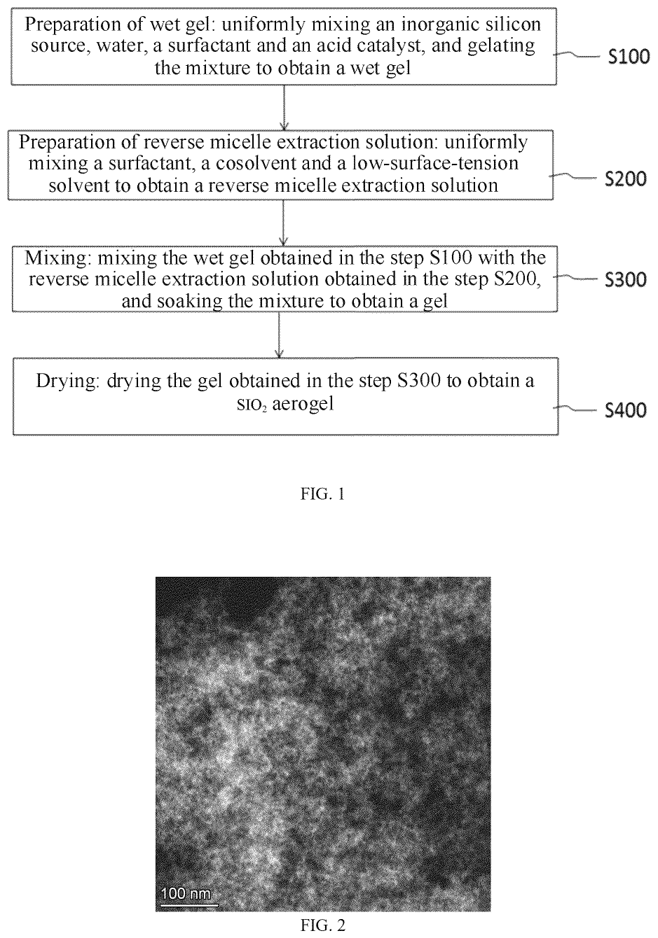

With reference to FIG. 1, in some embodiments of the present application, a preparation method for a SiO₂ aerogel is provided, which comprises the following steps:
S100. preparation of wet gel: uniformly mixing an inorganic silicon source, water, a surfactant and an acid catalyst, and gelating the mixture to obtain a wet gel;
S200. preparation of reverse micelle extraction solution: uniformly mixing a surfactant, a cosolvent and a low-surface-tension solvent to obtain a reverse micelle extraction solution;
S300. mixing: mixing the wet gel obtained in the step S100 with the reverse micelle extraction solution obtained in the step S200, and soaking the mixture to obtain a gel; and
S400. drying: drying the gel obtained in the step S300 to obtain the SiO₂ aerogel.

A reverse micelle extraction method is a technological method in which the surfactant is dissolved in an organic solvent to form a reverse micelle, a protein is solubilized in a water pool of the reverse micelle, and finally, the protein is back-extracted with a solution of a strong ionic strength and then dried. In detail, the reverse micelle is a spontaneous aggregate of the surfactant in a nonpolar organic solvent, and a dipole-dipole interaction leads to a change of free energy in a micellization process of the surfactant, which promotes the generation of nano-scale aggregation of colloid. In an interior of the reverse micelle, polar head groups of molecules of the surfactant aggregate with each other to form a “polar core”, which can solubilize polar substances such as water and protein, and a reverse micelle system solubilizing a large amount of water is namely a microemulsion. The water exists in the reverse micelle as free water and bound water, and the latter has different physical and chemical properties from bulk water, such as an increased viscosity, a decreased dielectric constant and a destroyed spatial network structure formed by hydrogen bonds. The reverse micelle with the solubilized substances (such as water and protein) is basically considered as an approximate sphere with single-layer amphiphilic molecule aggregation, the reverse micelle system is in a state of constant motion, and a collision frequency between reverse micelles is 109-1011 times/second. Moreover, the solubilized substances (such as water and protein) in the reverse micelle are frequently exchanged. The reverse micellar extraction is used for protein separation and purification: the protein is dissolved in a small water pool, which is surrounded by a layer of water film and polar heads of the surfactant for protection, so as to avoid the protein from contacting with the organic solvent to be inactivated, and by changing a pH value, a salt concentration and other conditions, the protein may be returned to a water phase, thus achieving the purpose of extraction, separation and purification of the protein, wherein an electrostatic interaction between the protein and the polar heads of the surfactant is a main driving force. The reverse micelle extraction technology has many outstanding advantages, such as mild conditions, no denaturation of substances such as protein, simple technology and no pollution. However, the reverse micelle extraction technology is used to extract a plant protein in most of the prior arts. It is found by the inventor of the present application that the reverse micelle extraction has not been applied to the preparation technology for the SiO₂ aerogel before the application date of the present application. In view of this, the present application provides the preparation method for the SiO₂ aerogel which adopts the reverse micelle extraction, so as to effectively ease the defects in current technological method for preparing the aerogel by the reverse micelle extraction technology, thus providing a new idea for the production of the aerogel.

Therefore, based on the above settings, according to the technical solution provided by the embodiment of the present invention, the preparation method in the embodiment of the present invention is used, the inorganic silicon source, such as an inorganic self-hydrophobic silicon source, serving as a precursor, is low in cost, widely available and easy to obtain, can solve the problems of limited production capacity of currently adopted organic silicon source, high price of organic silicon modifier and the like, and is conductive to reducing a production cost. Meanwhile, a cheap inorganic self-hydrophobic silicon source system is utilized, the surfactant is added at the same time to wrap a hydrophobic group of the inorganic self-hydrophobic silicon source, which avoids the hydrophobic group from being wrapped by a gel matrix during secondary cluster formation in a sol-gel process, thus greatly reducing or even losing hydrophobic characteristics. Moreover, organic reagents such as alcohol are not used in the sol-gel process, thus achieving green environmental protection and a low price.

Meanwhile, according to the preparation method provided by the present invention, the SiO₂ aerogel is prepared by an acid-catalyzed one-step gelation method, and by changing an electrolyte concentration or adding some ions with specific adsorption capacity, a thickness of a diffusion layer is compressed, and an electrodynamic potential is changed, so that a gelation time may be freely controlled within 0.05 hour-2 hours, and the gelation time may be controlled according to a production flow. Therefore, the operation is convenient, the working procedure is simplified, and the efficiency is improved.

Further, according to the preparation method provided by the present invention, a reverse micelle extraction step is utilized instead of a wet gel solvent replacement step and a deionization step, wherein, when the molecules of the surfactant and the cosolvent are dissolved in the low-surface-tension solvent to reach a certain critical concentration, a nano-aggregate with an inward hydrophilic end, an outward lipophilic end and a micro water content in the middle is formed, which is the reverse micelle, and moreover, the cosolvent can promote the dissolution of the surfactant to form a relatively stable and large-size reverse micelle structure. The reverse micelle solution has a water-in-oil structure, and in the case of contacting with the wet gel, water in the wet gel is “carried” out due to a high-speed collision exchange effect between the reverse micelles, and ions in the water are brought out at the same time. With the water-insoluble low-surface-tension solvent entering gel pores, the surfactant of the hydrophobic group (—CH₃) wrapped on the three-dimensional gel matrix is gradually desorbed, and the lipophilic hydrophobic group —CH₃ targets to a solid-liquid interface of the gel matrix, which further promotes an outward migration rate of water phase in the gel and improves a replacement rate of reverse micelle extraction. In addition, under an action of heating, an outward migration speed of water in the gel pores can be significantly improved. Therefore, the preparation of the reverse micelle extraction solution can avoid the complicated solvent replacement process, simplify the working procedure, shorten the production cycle and improve the production efficiency.

In addition, according to the preparation method provided by the present invention, an ambient-pressure staged drying technology is adopted, and an evaporated solvent may be reused, which improves a utilization rate of resources and is conductive to reducing a material cost. Moreover, waste liquid or waste gas generated in each step in the aerogel preparation and production process is recycled through a separation technology, thus having zero environmental pollution, and being safe, environmentally friendly and low in cost.

In this embodiment, the surfactant in the step S100 and the surfactant in the step S200 may be the same type of surfactant or different types of surfactants. In preferred embodiments of the present invention, the surfactant in the step S100 and the surfactant in the step S200 are the same type of surfactant, which achieves simple composition, easy operation and good uniformity.

It should be noted that, in the SiO₂ aerogel preparation process, the wet gel may be prepared first, and then the reverse micelle extraction solution is prepared; or, the reverse micelle extraction solution may be prepared first, and then the wet gel is prepared; or, the reverse micelle extraction solution and the wet gel may be prepared at the same time. That is to say, an order of the step S100 and the step S200, which is namely a preparation order of the reverse micelle extraction solution and the wet gel, is not limited in this embodiment.

In some specific embodiments, a preparation method for the SiO₂ aerogel comprises the following steps.

In S100 of preparation of wet gel, an inorganic silicon source, water, a surfactant and an acid catalyst are uniformly mixed, and gelated to obtain a wet gel.

It should be pointed out that, in a preparation method for the wet gel by gelation, the gelation is a conventional technical means in the art, and this embodiment has no specific requirements for the gelation process. Illustratively, the gelation process may be implemented by one or a combination of several modes of standing, heating and microwave treatments. Meanwhile, this embodiment has no special requirements for the gelation temperature and the gelation time, for example, by changing the electrolyte concentration or adding some ions with specific adsorption capacity, the thickness of the diffusion layer is compressed, and the electrodynamic potential is changed, so that the gelation time may be freely controlled within 0.05 hour-2 hours, and the gelation time may be controlled according to the production flow.

Optionally, a mass ratio of the inorganic silicon source to the water, the surfactant and the acid catalyst is 1:2-4:0.02-0.06:0.05-3. Further, the mass ratio of the inorganic silicon source to the water, the surfactant and the acid catalyst is 1:2.5-3.5:0.03-0.05:0.1-2. Illustratively, the mass ratio of the inorganic silicon source to the water, the surfactant and the acid catalyst may be 1:2:0.02:0.05, 1:3:0.04:0.2, 1:3:0.05:1.5, 1:4:0.05:2, 1:4:0.06:3, etc. In this way, within the above raw material ratio range, better technical effects can be obtained at a lower cost.

Optionally, the water may be deionized water. Certainly, in other embodiments, other types of water, such as distilled water and tap water, may also be adopted, which is not limited in this embodiment.

Optionally, the inorganic silicon source comprises, but is not limited to, at least one of water-soluble silicate, water-soluble alkane-modified silicate or alkaline silica sol; and preferably, the inorganic silicon source at least comprises the water-soluble alkane-modified silicate, that is, the inorganic silicon source preferably comprises the water-soluble alkane-modified silicate, and may further comprise one or two of the water-soluble silicate and the alkaline silica sol, and a hydrophobic property may be provided by the inorganic silicon source of the water-soluble alkane-modified silicate.

In some specific embodiments, the inorganic silicon source may be a mixture of the water-soluble silicate and the water-soluble alkane-modified silicate; or a mixture of the water-soluble alkane-modified silicate and the alkaline silica sol; or a mixture of the water-soluble silicate, the water-soluble alkane-modified silicate and the alkaline silica sol.

Optionally, the water-soluble silicate comprises, but is not limited to, at least one of sodium silicate, potassium silicate, lithium silicate, hydrated sodium silicate, hydrated potassium silicate or hydrated lithium silicate. For example, the water-soluble silicate may be the sodium silicate, the potassium silicate, the lithium silicate, the hydrated sodium silicate, the hydrated potassium silicate, the hydrated lithium silicate, or a combination of any two or more of the above substances, which will not be listed herein.

Optionally, the water-soluble alkane-modified silicate is CₙH₂ₙ₊₁Si(OM)₃, wherein n<8, and M comprises at least one of Na, K or Li. For example, M may be Na, K, Li, etc.

Optionally, a content of SiO₂ in the alkaline silica sol is 25%-40%, such as 25%, 30%, 35% and 40%. Optionally, a pH value of the alkaline silica sol is 9-11, such as 9, 10 and 11. Optionally, an average particle size of the alkaline silica sol is 10 nm to 20 nm, such as 10 nm, 12 nm, 14 nm, 15 nm, 16 nm, 18 nm and 20 nm.

It should be noted that this embodiment has no restriction on a specific type or a source of the water-soluble silicate, the water-soluble alkane-modified silicate or the alkaline silica sol above, and those skilled in the art may make flexible choice according to actual needs, as long as the purpose of the present invention is not limited. For example, the inorganic self-hydrophobic silicon source system applied to the aerogel, which is familiar to those skilled in the art or has an improved structure, may be commercially available or prepared by its user.

Optionally, the acid catalyst comprises, but is not limited to, at least one of hydrofluoric acid, hydrochloric acid, sulfuric acid, nitric acid, phosphoric acid, oxalic acid, acetic acid, ammonium chloride, sodium bisulfate, ammonium sulfate or ammonium fluoride. For example, the acid catalyst may be the hydrofluoric acid, the hydrochloric acid, the sulfuric acid, the nitric acid, the phosphoric acid, the oxalic acid, the acetic acid, the ammonium chloride, the sodium bisulfate, the ammonium sulfate, the ammonium fluoride, or a combination of any two or more of the above substances, which will not be listed herein.

Optionally, the surfactant comprises, but is not limited to, at least one of sodium dodecyl sulfate, cetyl trimethyl ammonium bromide, tetradecyl betaine, polyoxyethylene ether, sodium perfluorooctane sulfonate, sodium perfluorooctanoate, 1-Hexadecylsulfonic acid sodium salt, sodium perfluorododecyl sulfate or perfluorododecyl polyoxyethylene ether. For example, the surfactant may be the sodium dodecyl sulfate, the cetyl trimethyl ammonium bromide, the tetradecyl betaine, the polyoxyethylene ether, the sodium perfluorooctane sulfonate, the sodium perfluorooctanoate, the 1-Hexadecylsulfonic acid sodium salt, the sodium perfluorododecyl sulfate, the perfluorododecyl polyoxyethylene ether, or a combination of any two or more of the above substances, which will not be listed herein.

In addition, in other embodiments, the inorganic silicon source, the surfactant and the acid catalyst are not limited to those listed above, and other types of inorganic silicon sources, surfactants and acid catalysts may be adopted under the condition of meeting the requirements of rapidly preparing the SiO₂ aerogel with a good performance at a low cost, and the like, which will not be described in detail herein.

In S200 of preparation of reverse micelle extraction solution, a surfactant, a cosolvent and a low-surface-tension solvent are uniformly mixed to obtain a reverse micelle extraction solution for later use.

Optionally, a mass ratio of the surfactant to the cosolvent and the low-surface-tension solvent is 1:8-25:120-250. Further, the mass ratio of the surfactant to the cosolvent and the low-surface-tension solvent is 1:10-20:130-200. Illustratively, the mass ratio of the surfactant to the cosolvent and the low-surface-tension solvent may be 1:8:120, 1:10:150, 1:12:160, 1:15:180, 1:15:200, 1:20:200, 1:22:225, 1:25:250, etc. In this way, within the above raw material ratio range, better technical effects can be obtained at a lower cost.

A specific type of the surfactant in the step S200 may refer to the description of the surfactant in the step S100, which will not be repeated herein.

Optionally, the cosolvent comprises, but is not limited to, at least one of an alcohol solvent, an aldehyde solvent, a ketone solvent, an ether solvent or a phenol solvent. Optionally, the cosolvent comprises, but is not limited to, at least one of methanol, n-propanol, isopropanol, n-butanol, isobutanol, n-pentanol, isopentanol, 1-hexanol, 2-hexanol, 1-octanol, ethanol, acetaldehyde, acetone, ether or p-nonylphenol. For example, the cosolvent may be the methanol, the n-propanol, the isopropanol, the n-butanol, the isobutanol, the n-pentanol, the isopentanol, the 1-hexanol, the 2-hexanol, the 1-octanol, the ethanol, the acetaldehyde, the acetone, the ether, the p-nonylphenol, or a combination of any two or more of the above substances, which will not be listed herein.

Optionally, the above low-surface-tension solvent is a water-insoluble low-surface-tension solvent, and the water-insoluble low-surface-tension solvent comprises, but is not limited to, at least one of an alkane solvent, an alkene solvent or a benzene solvent. Optionally, the low-surface-tension solvent comprises, but is not limited to, at least one of n-hexane, n-heptane, n-pentane, toluene, hexamethyl disiloxane, trimethyl hydroxysilane, hexamethyl cyclotrisiloxane, octamethyl cyclotetrasiloxane, monochlorotrifluoropropene, monofluorotrichloromethane or 1,1,2-trifluorotrichloroethane. For example, the low-surface-tension solvent may be the n-hexane, the n-heptane, the n-pentane, the toluene, the hexamethyl disiloxane, the trimethyl hydroxysilane, the hexamethyl cyclotrisiloxane, the octamethyl cyclotetrasiloxane, the monochlorotrifluoropropene, the monofluorotrichloromethane, the 1,1,2-trifluorotrichloroethane, or a combination of any two or more of the above substances, which will not be listed herein.

In addition, in other embodiments, the cosolvent and the low-surface-tension solvent are not limited to those listed above, and other types of cosolvents and low-surface-tension solvents may be adopted under the condition of meeting the requirements of rapidly preparing the SiO₂ aerogel with a good performance at a low cost, and the like, which will not be described in detail herein.

In S300 of mixing, the wet gel obtained in the step S100 is mixed with the reverse micelle extraction solution obtained in the step S200, and the mixture is soaked to obtain a gel. In this embodiment, an addition order of the wet gel and the reverse micelle extraction solution is not required. For example, the reverse micelle extraction solution may be added into the wet gel, or the wet gel may be added into the reverse micelle extraction solution. However, in a preferred embodiment of the present invention, the wet gel obtained in the step S100 is usually added (placed) into the reverse micelle extraction solution obtained in the step S200, and then the mixture is soaked.

Optionally, a soaking time is 0.5 hour-6 hours, and a soaking temperature is 25° C.-50° C. Further, the soaking time is 1 hour-4 hours, and the soaking temperature is 30° C.-45° C. Illustratively, the soaking time may be 0.5 hour, 1 hour, 1.5 hours, 2 hours, 3 hours, 3.5 hours, 4 hours, 5 hours, 6 hours, etc., and the soaking temperature may be 25° C., 28° C., 30° C., 35° C., 40° C., 45° C., 50° C., etc.

Optionally, a mass ratio of the wet gel to the reverse micelle extraction solution is 1:1.5-2.5. Optionally, the mass ratio of the wet gel to the reverse micelle extraction solution is 1:1.8-2.2.Illustratively, the mass ratio of the wet gel to the reverse micelle extraction solution may be 1:1.5, 1:1.8, 1:2, 1:2.2, 1:2.5, etc.

In S400 of drying, the gel obtained in the step S300 is dried to obtain the SiO₂ aerogel.

According to specific implementation of the present invention, in the preparation method for the SiO₂ aerogel by drying, such as ambient-pressure drying, the drying may be a conventional technical means in the art, such as ambient-pressure heating drying. Alternatively, in other embodiments, the drying may be vacuum drying.

Optionally, the drying is ambient-pressure staged heating drying. Specifically, the staged heating drying comprises: under an ambient pressure, treating at 70° C.-90° C. for 1 hour-2 hours first, and then treating at 140° C.-160° C. for 1 hour-2 hours. Further, the staged heating drying comprises: under an ambient pressure, treating at 80° C. for 1 hour-2 hours first, and then treating at 150° C. for 1 hour-2 hours. Illustratively, the staged heating drying comprises: treating at 70° C., 75° C., 80° C., 90° C., etc. for 1 hour, 1.5 hours, 2 hours, etc. first, and then treating at 140° C., 145° C., 150° C., 155° C., 160° C., etc. for 1 hour, 1.5 hours, 2 hours, etc.

An ambient-pressure staged heating drying method is adopted, which has simple equipment, a good drying effect, a low cost and easy operation.

Optionally, evaporated solvent is collected during the drying, and the collected evaporated solvent is returned to the step S200 or the step S300 for reuse.

In the ambient-pressure preparation method for the SiO₂ aerogel of the present invention, corresponding devices or molds may be adopted to further prepare SiO₂ aerogel products comprising a powder, a block and a composite material (such as a SiO₂ aerogel fiber felt).

Further, the preparation method of the present invention may be used for preparing the SiO₂ aerogel and may also be used for preparing the SiO₂ aerogel composite material. When the SiO₂ aerogel composite material is prepared by the method, the step S100 in the above preparation method comprises: uniformly mixing the inorganic silicon source, the water, the surfactant and the acid catalyst to obtain a mixed solution; and impregnating a hydrophilic carrier with the mixed solution, and then gelating the carrier to obtain a wet gel composite material. In step S300, the wet gel composite material obtained in the step S100 is placed into the reverse micelle extraction solution obtained in the step S200, and the mixture is soaked to obtain a gel. In step S400, the gel obtained in the step S300 is dried to obtain the SiO₂ aerogel composite material.

It should be understood that, when the SiO₂ aerogel composite material is prepared, the hydrophilic carrier is mainly added in the step S100, and other steps, or specific operating conditions, raw material types, proportions and the like in various steps may refer to the description of preparation of the SiO₂ aerogel above, which will not be described in detail herein.

Optionally, the hydrophilic carrier comprises, but is not limited to, at least one of a glass fiber felt, a pre-oxidized fiber felt, a ceramic fiber felt, expanded perlite, sepiolite or a melamine foam. For example, the hydrophilic carrier may be the glass fiber felt, the pre-oxidized fiber felt, the ceramic fiber felt, the expanded perlite, the sepiolite, the melamine foam, or a combination of any two or more of the above substances, which will not be listed herein.

The preparation method technology for the aerogel material provided by the present invention is simple in method technology, strong in operability, low in raw material cost and easily available, does not need the steps such as organic solvent replacement and deionization and does not need supercritical equipment drying, and has mild reaction conditions, a low preparation cost and a short production cycle, thus having good industrial production and application prospects.

In some embodiments, a SiO₂ aerogel is provided, wherein the SiO₂ aerogel is prepared by the above preparation method. Optionally, a SiO₂ aerogel composite material is further provided, wherein the SiO₂ aerogel composite material is prepared by the above preparation method.

In some embodiments, a specific surface area of the prepared SiO₂ aerogel is ≥600 m²/g, for example, the specific surface area of the SiO₂ aerogel is 600-1000 m²/g; and a thermal conductivity coefficient of the SiO₂ aerogel is ≤0.015 W/(m·K), for example, the thermal conductivity coefficient of the v aerogel is 0.012-0.015 W/(m·K). Optionally, a density of the SiO₂ aerogel is ≤0.15 g/cm³, for example, the density of the SiO₂ aerogel is 0.05-0.15g/cm³. An average pore size of the prepared SiO₂ aerogel is ≤20 nm, for example, the average pore size of the SiO₂ aerogel is 10-20 nm. A contact angle of the prepared SiO₂ aerogel is >90°.

In some embodiments, a specific surface area of the SiO₂ aerogel composite material is ≥600 m²/g, and a thermal conductivity coefficient of the SiO₂ aerogel composite material is ≤0.021 W/(m·K).

Thus, it can be seen that the present invention can solve the problems of limited production capacity of organic silicon source, high price of organic silicon modifier, high production cost and the like in current preparation, the preparation method is low in production cost and short in preparation cycle, and the prepared SiO₂ aerogel product has excellent performance.

The embodiments of the present invention are described in detail hereinafter. The embodiments described hereinafter are illustrative, and only intended to explain the present invention, and shall not be understood as limiting the present invention. Specific technologies or conditions not indicated in the embodiments should follow the technologies or conditions described in the literature in the art or the product specification.

### Embodiment 1

A preparation method for a SiO₂ aerogel comprised the following steps.

In S100 of preparation of wet gel, a mixture of water-soluble silicate (water glass) and water-soluble alkane-modified silicate (CH₃Si(ONa)₃) (in a mass ratio of 1:1), deionized water, sodium dodecyl sulfate and a phosphoric acid were uniformly mixed and gelated to obtain a wet gel; wherein, a mass ratio of an inorganic silicon source to water, a surfactant and an acid catalyst was 1:4:0.02:0.05.

In S200 of preparation of reverse micelle extraction solution: sodium dodecyl sulfate, methanol and hexamethyl disiloxane were uniformly mixed to obtain a reverse micelle extraction solution; wherein, a mass ratio of a surfactant to a cosolvent and a low-surface-tension solvent was 1:15:200.

In S300 of mixing, the wet gel obtained in the step S100 was added into the reverse micelle extraction solution obtained in the step S200, and the mixture was soaked to obtain a gel; wherein, a soaking time was 4.0 hours, and a soaking temperature was 45° C.; and a mass ratio of the wet gel to the reverse micelle extraction solution was 1:2.0.

In S400 of drying, the gel obtained in the step S300 was dried to obtain the SiO₂ aerogel; and an evaporated solvent was collected during drying and returned to the above step for reuse. The drying was ambient-pressure staged heating drying, which comprised: under an ambient pressure, treating at 80° C. for 1 hour first, and then treating at 150° C. for 1 hour.

Performance parameters of the SiO₂ aerogel product prepared in this embodiment were measured as follows: a thermal conductivity coefficient was 0.012 W/(m·K), a tap density was 0.12 g/mL, a specific surface area was 735.3 m²/g, and a contact angle with water was 169°.

In addition, FIG. 2 shows a microscopic TEM diagram of the SiO₂ aerogel prepared in this embodiment. It can be seen from FIG. 2 that the aerogel is formed by nano-particle packing and has a three-dimensional net structure, wherein a skeleton diameter is about 10 nm, and a pore size is less than 50 nm.

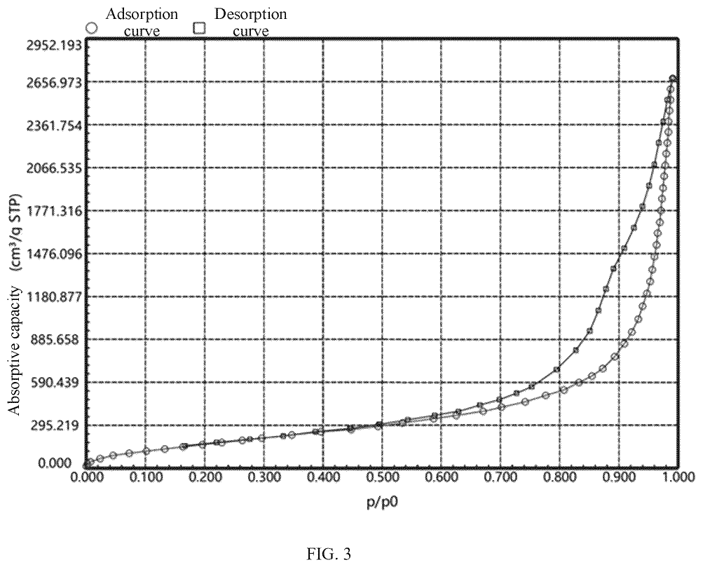

FIG. 3 shows isothermal nitrogen adsorption and desorption curves of the SiO₂ aerogel prepared in this embodiment. According to a BET equation, a multi-point BET specific surface area of the SiO₂ aerogel prepared in this embodiment is 735.3 m²/g, and according to a De Boer theory and an adsorption-desorption curve shape, the SiO₂ aerogel prepared in this embodiment has a cylindrical pore structure.

### Comparative Example 1

A preparation method for SiO₂ of this comparative example was basically the same as that of Embodiment 1, and a main difference lied in step S100.

In the step S100 of Comparative Example 1, no surfactant (sodium dodecyl sulfate) was added. It was proved by experiments that Comparative Example 1 could also be the gel, but after the gel was treated with the reverse micelle extraction solution and dried at an ambient pressure, the obtained product was obviously densified. It was measured that a tap density of the SiO₂ aerogel prepared in Comparative Example 1 was 0.86 g/mL, and a specific surface area of the v aerogel was 92.2 m²/g. The SiO₂ aerogel did not have an aerogel nanoporous structure.

### Comparative Example 2

A preparation method for SiO₂ of this comparative example was basically the same as that of Embodiment 1, and a main difference lied in step S200.

In the step S200 of Comparative Example 2, no cosolvent (methanol) was added. It was proved by experiments that, in Comparative Example 2, the surfactant (sodium dodecyl sulfate) could not be fully dissolved in the water-insoluble low-surface-tension solvent (hexamethyl disiloxane), and then the product obtained after gel treatment and ambient-pressure drying was similar to Comparative Example 1. The SiO₂ aerogel did not have an aerogel nanoporous structure.

### Comparative Example 3

A preparation method for SiO₂ of this comparative example was basically the same as that of Embodiment 1, and a main difference lied in step S200.

In the step S200 of Comparative Example 3, no surfactant was added. It was proved by experiments that, in Comparative Example 3, the product obtained after gel treatment and ambient-pressure drying was similar to Comparative Example 1. The SiO₂ aerogel did not have an aerogel nanoporous structure.

### Embodiment 2

A preparation method for a SiO₂ aerogel comprised the following steps.

In S100 of preparation of wet gel, a mixture of alkaline silica sol (SiO₂ content 25%-26%, pH value=9 and average particle size 10 nm) and water-soluble alkane-modified silicate (C₂H₅Si(ONa)₃) (in a mass ratio of 1:2), deionized water, sodium dodecyl sulfate and a hydrofluoric acid were uniformly mixed and gelated to obtain a wet gel; wherein, a mass ratio of an inorganic silicon source to water, a surfactant and an acid catalyst was 1:4:0.06:0.3.

In S200 of preparation of reverse micelle extraction solution: sodium dodecyl sulfate, isopropanol and n-hexane were uniformly mixed to obtain a reverse micelle extraction solution; wherein, a mass ratio of a surfactant to a cosolvent and a low-surface-tension solvent was 1:25:250.

In S300 of mixing, the wet gel obtained in the step S100 was added into the reverse micelle extraction solution obtained in the step S200, and the mixture was soaked to obtain a gel; wherein, a soaking time was 0.5 hour, and a soaking temperature was 50° C.; and a mass ratio of the wet gel to the reverse micelle extraction solution was 1:2.5.

In S400 of drying, the gel obtained in the step S300 was dried to obtain the SiO₂ aerogel; and an evaporated solvent was collected during drying and returned to the above step for reuse. The drying was ambient-pressure staged heating drying, which comprised: under an ambient pressure, treating at 80° C. for 2 hours first, and then treating at 150° C. for 2 hours.

Performance parameters of the SiO₂ aerogel product prepared in this embodiment were measured as follows: a thermal conductivity coefficient was 0.014 W/(m·K), a tap density was 0.13 g/mL, a specific surface area was 861.3 m²/g, and a contact angle with water was 159°.

### Embodiment 3

A preparation method for a SiO₂ aerogel comprised the following steps.

In S100 of preparation of wet gel, a mixture of water-soluble alkane-modified silicate (C₄H₉Si(ONa)₃) and alkaline silica sol, deionized water, cetyl trimethyl ammonium bromide, a hydrochloric acid and a hydrofluoric acid were uniformly mixed and gelated to obtain a wet gel; wherein, a mass ratio of an inorganic silicon source to water, a surfactant and an acid catalyst was 1:2:0.02:0.05, and a mass ratio of the hydrochloric acid to the hydrofluoric acid was 1:2.

In S200 of preparation of reverse micelle extraction solution: cetyl trimethyl ammonium bromide, isobutanol, 2-hexanol and hexamethyl cyclotrisiloxane were uniformly mixed to obtain a reverse micelle extraction solution; wherein, a mass ratio of a surfactant to a cosolvent and a low-surface-tension solvent was 1:8:120, and a mass ratio of the isobutanol to the 2-hexanol was 1:1.

In S300 of mixing, the wet gel obtained in the step S100 was added into the reverse micelle extraction solution obtained in the step S200, and the mixture was soaked to obtain a gel; wherein, a soaking time was 6 hours, and a soaking temperature was 25° C.; and a mass ratio of the wet gel to the reverse micelle extraction solution was 1:1.5.

In S400 of drying, the gel obtained in the step S300 was dried to obtain the SiO₂ aerogel; and an evaporated solvent was collected during drying and returned to the above step for reuse. The drying was ambient-pressure staged heating drying, which comprised: under an ambient pressure, treating at 80° C. for 2 hours first, and then treating at 150° C. for 2 hours.

Performance parameters of the SiO₂ aerogel product prepared in this embodiment were measured as follows: a thermal conductivity coefficient was 0.013 W/(m·K), a tap density was 0.12 g/mL, a specific surface area was 688.5 m²/g, and a contact angle with water was 165°.

### Embodiment 4

A preparation method for a SiO₂ aerogel glass fiber felt (SiO₂ aerogel composite material) comprised the following steps.

In S100 of preparation of wet gel, a mixture of water-soluble alkane-modified silicate (CH₃Si(ONa)₃) and water-soluble silicate (hydrated sodium silicate), deionized water, cetyl trimethyl ammonium bromide, an acetic acid and a hydrochloric acid were uniformly mixed, and a hydrophilic glass fiber felt was dipped and pulled in the above mixed solution, and gelated to obtain a wet gel composite material; wherein, a mass ratio of an inorganic silicon source to water, a surfactant and an acid catalyst was 1:2:0.02:0.3, and a mass ratio of the acetic acid to the hydrochloric acid was 3:1.

In S200 of preparation of reverse micelle extraction solution: cetyl trimethyl ammonium bromide, ethanol, isopropanol and hexamethyl disiloxane were uniformly mixed to obtain a reverse micelle extraction solution; wherein, a mass ratio of a surfactant to a cosolvent and a low-surface-tension solvent was 1:8:120, and a mass ratio of the ethanol to the isopropanol was 1:1.

In S300 of mixing, the wet gel composite material obtained in the step S100 was added into the reverse micelle extraction solution obtained in the step S200, and the mixture was soaked to obtain a gel; wherein, a soaking time was 4.5 hours, and a soaking temperature was 28° C.; and a mass ratio of the wet gel composite material to the reverse micelle extraction solution was 1:1.5.

In S400 of drying, the gel obtained in the step S300 was dried to obtain the SiO₂ aerogel glass fiber felt; and an evaporated solvent was collected during drying and returned to the above step for reuse. The drying was ambient-pressure staged heating drying, which comprised: under an ambient pressure, treating at 80° C. for 2 hours first, and then treating at 150° C. for 2 hours.

Performance parameters of the SiO₂ aerogel glass fiber felt prepared in this embodiment were measured as follows: a thermal conductivity coefficient was 0.018 W/(m·K), a density was 0.21 g/mL, a specific surface area was 699.0 m²/g, and a contact angle with water was 166°.

The parts not described in detail in the specification of the present invention are widely-known technologies to those skilled in the art.

In the description of the present invention, the terms “first” and “second” are only used for descriptive purposes, but cannot be understood as indicating or implying relative importance, or implicitly indicating the number of indicated technical features. Thus, the feature defined by “first” and “second” may explicitly or implicitly comprise at least one feature.

In the present invention, the terms “one embodiment”, “some embodiments”, “example”, “specific example”, “some examples”, etc., refer to that specific features, structures, materials or characteristics described with reference to the embodiments or examples are included in at least one embodiment or example of the present invention. In the specification, the schematic representation of the above terms does not necessarily refer to the same embodiment or example. Moreover, the specific features, structures, materials or characteristics described may be combined in any one or more embodiments or examples in a suitable manner. In addition, in the case of having no mutual contradiction, those skilled in the art may join and combine different embodiments or examples described in the specification and the characteristics of the different embodiments or examples.

Finally, it should be noted that: the above embodiments are only used to illustrate the technical solutions of the present invention, rather than limiting the present invention. Although the present invention has been described in detail with reference to the foregoing embodiments, those of ordinary skills in the art should understand that they can still modify the technical solutions described in the foregoing embodiments or can equivalently replace some of the technical features therein. However, these modifications or replacements do not make the essence of the corresponding technical solutions deviate from the spirit and scope of the technical solutions of the embodiments of the present invention.

We claim:

1. A preparation method for a SiO₂ aerogel, comprising the following steps:
S100: uniformly mixing an inorganic silicon source, water, a surfactant and an acid catalyst, and gelating the mixture to obtain a wet gel;
S200: uniformly mixing a surfactant, a cosolvent and a low-surface-tension solvent to obtain a reverse micelle extraction solution;
S300: mixing the wet gel obtained in the step S100 with the reverse micelle extraction solution obtained in the step S200, and soaking the mixture to obtain a gel; and
S400: drying the gel obtained in the step S300 to obtain the SiO₂ aerogel.

2. The preparation method for the SiO₂ aerogel according to claim 1, wherein, when a SiO₂ aerogel composite material is prepared by the method, the step S100 in the preparation method comprises:
uniformly mixing the inorganic silicon source, the water, the surfactant and the acid catalyst to obtain a mixed solution; and
impregnating a hydrophilic carrier with the mixed solution, and then gelating the carrier to obtain a wet gel composite material.

3. The preparation method for the SiO₂ aerogel according to claim 2, wherein the hydrophilic carrier comprises at least one of a glass fiber felt, a pre-oxidized fiber felt, a ceramic fiber felt, expanded perlite, sepiolite or a melamine foam.

4. The preparation method for the SiO₂ aerogel according to claim 1, wherein, in the step S100, a mass ratio of the inorganic silicon source to the water, the surfactant and the acid catalyst is 1:2-4:0.02-0.06:0.05-3; and/or,
in the step S200, a mass ratio of the surfactant to the cosolvent and the low-surface-tension solvent is 1:8-25:120-250.

5. The preparation method for the SiO₂ aerogel according to claim 1, wherein, in the step S300, a soaking time is 0.5 hour to 6 hours, and a soaking temperature is 25° C.-50° C.;
in the step S300, a mass ratio of the wet gel to the reverse micelle extraction solution is 1:1.5-2.5; and
in the step S400, the drying is ambient-pressure staged heating drying;
the staged heating drying comprises: under an ambient pressure, treating at 70° C.-90° C. for 1 hour-2 hours first, and then treating at 140° C.-160° C. for 1 hour-2 hours; and
evaporated solvent is collected during the drying, and the collected solvent is returned to the step S200 or the step S300 for reuse.

6. The preparation method for the SiO₂ aerogel according to claim 1, wherein the inorganic silicon source comprises at least one of water-soluble silicate, water-soluble alkane-modified silicate or alkaline silica sol.

7. The preparation method for the SiO₂ aerogel according to claim 6, wherein the inorganic silicon source is the water-soluble alkane-modified silicate, or a mixture of the water-soluble alkane-modified silicate and the water-soluble silicate, or a mixture of the water-soluble alkane-modified silicate and the alkaline silica sol, or a mixture of the water-soluble alkane-modified silicate, the water-soluble silicate and the alkaline silica sol;
the water-soluble silicate comprises at least one of sodium silicate, potassium silicate, lithium silicate, hydrated sodium silicate, hydrated potassium silicate or hydrated lithium silicate;
the water-soluble alkane-modified silicate is CₙH₂ₙ₊₁Si(OM)₃, wherein n<8, and M comprises at least one of Na, K or Li;
a content of SiO₂ in the alkaline silica sol is 25%-40%; and/or,
a pH value of the alkaline silica sol is 9-11; and/or,
an average particle size of the alkaline silica sol is 10 nm to 20 nm.

8. The preparation method for the SiO₂ aerogel according to claim 1, wherein the acid catalyst comprises at least one of hydrofluoric acid, hydrochloric acid, sulfuric acid, nitric acid, phosphoric acid, oxalic acid, acetic acid, ammonium chloride, sodium bisulfate, ammonium sulfate or ammonium fluoride; and/or,
the surfactant comprises at least one of sodium dodecyl sulfate, cetyl trimethyl ammonium bromide, tetradecyl betaine, polyoxyethylene ether, sodium perfluorooctane sulfonate, sodium perfluorooctanoate, 1-Hexadecylsulfonic acid sodium salt, sodium perfluorododecyl sulfate or perfluorododecyl polyoxyethylene ether.

9. The preparation method for the SiO₂ aerogel according to claim 1, wherein the cosolvent comprises at least one of an alcohol solvent, an aldehyde solvent, a ketone solvent, an ether solvent or a phenol solvent; and/or,
the low-surface-tension solvent comprises at least one of an alkane solvent, an alkene solvent or a benzene solvent.

10. The preparation method for the SiO₂ aerogel according to claim 9, wherein the low-surface-tension solvent comprises at least one of n-hexane, n-heptane, n-pentane, toluene, hexamethyl disiloxane, trimethyl hydroxysilane, hexamethyl cyclotrisiloxane, octamethyl cyclotetrasiloxane, monochlorotrifluoropropene, monofluorotrichloromethane or 1,1,2-trifluorotrichloroethane.

11. The preparation method for the SiO₂ aerogel according to claim 9, wherein the cosolvent comprises at least one of methanol, n-propanol, isopropanol, n-butanol, isobutanol, n-pentanol, isopentanol, 1-hexanol, 2-hexanol, 1-octanol, ethanol, acetaldehyde, acetone, ether or p-nonylphenol.
